(19) United States
(12) Patent Application Publication
(10) Pub. No.: US 2018/0011636 A1
(43) Pub. Date: Jan. 11, 2018

(54) INFORMATION PROCESSING APPARATUS AND METHOD OF ACCESSING A MEMORY

(71) Applicant: FUJITSU LIMITED, Kawasaki-shi (JP)

(72) Inventor: Kosuke SUZUKI, Ota (JP)

(73) Assignee: FUJITSU LIMITED, Kawasaki-shi (JP)

(21) Appl. No.: 15/600,931

(22) Filed: May 22, 2017

(30) Foreign Application Priority Data
Jul. 5, 2016 (JP) 2016-133238

(51) Int. Cl. G06F 3/06

(52) U.S. Cl. CPC G06F 3/0604; G06F 3/064; G06F 3/0685

(57) ABSTRACT

An information processing apparatus includes a memory, a processor, and a memory control circuit configured to execute receiving first data from the processor, receive a request that requires to restrict a change in write order of a plurality of pieces of data including the first data to the first memory, determine whether a storing process of the first data into a buffer is executed, transmit a notification to the processor when the storing process of the first data into the buffer is executed, receive second data included in the plurality of pieces of data transmitted from the processor based on the notification, store the second data into the buffer, execute a first writing process of writing the first data stored in the buffer to the memory, and execute a second writing process of writing the second data stored in the buffer to the memory after the first writing process.

### CROSS-REFERENCE TO RELATED APPLICATION

This application is based upon and claims the benefit of priority of the prior Japanese Patent Application No. 2016-133238, filed on Jul. 5, 2016, the entire contents of which are incorporated herein by reference.

### FIELD

The embodiments discussed herein are related to an information processing apparatus and a method of accessing a memory.

### BACKGROUND

The memory is roughly divided into a non-volatile memory such as a flash memory or the like that holds data without power supply, and a volatile memory such as a dynamic random access memory (DRAM) or the like that has to be supplied with power for holding data. For example, the speed of writing data to the flash memory is slower than the operation speed of a host device to which the flash memory is connected. Therefore, a controller for controlling the flash memory has a buffer memory such as a static random access memory (SRAM). This type of controller holds the data received from the host device in the buffer memory and writes the data held in the buffer memory to the flash memory. As related arts, Japanese Laid-open Patent Publication No. 2007-293898 is disclosed.

### SUMMARY

According to an aspect of the invention, an information processing apparatus includes a first memory, a processor, and a memory control circuit including a first buffer and coupled to the first memory and the processor, wherein the memory control circuit is configured to execute receiving first data from the processor, after the receiving of the first data, receive, from the processor, a request that requires to restrict a change in write order of a plurality of pieces of data including the first data to the first memory, determine whether a storing process of the first data into the first buffer is executed, transmit a first notification to the processor when the storing process of the first data into the first buffer is executed, receive second data included in the plurality of pieces of data transmitted from the processor based on the first notification, store the second data into the first buffer, execute a first writing process of writing the first data stored in the first buffer to the first memory, and execute a second writing process of writing the second data stored in the first buffer to the first memory after the first writing process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one embodiment of a memory controller and a memory access method;

FIG. 2 is a diagram illustrating another embodiment of the memory controller and the memory access method;

FIG. 3 is a diagram illustrating an example of a reception processing unit depicted in FIG. 2;

FIG. 4 is a diagram illustrating an example of update of a pointer depicted in FIG. 2;

FIG. 5 is a diagram illustrating an example of an operation of a first control unit and a first switch unit depicted in FIG. 2;

FIG. 6 is a diagram illustrating an example of an operation of a second switch unit depicted in FIG. 2;

FIG. 7 is a diagram illustrating an example of data update performed by an information processing apparatus in which the memory controller depicted in FIG. 2 is mounted;

FIG. 8 is a diagram illustrating an example of an operation of the information processing apparatus in which the memory controller depicted in FIG. 2 is mounted;

FIG. 9 is a diagram illustrating still another embodiment of the memory controller and the memory access method;

FIG. 10 is a diagram illustrating an example of an operation of a second switch unit and a second control unit depicted in FIG. 9; and

FIG. 11 is a diagram illustrating still another embodiment of the memory controller and the memory access method.

### DESCRIPTION OF EMBODIMENTS

In recent years, a non-volatile memory called a storage class memory such as a magnetoresistive random access memory (MRAM), a phase change memory (PCM), a resistive random access memory (ReRAM) or the like has been introduced. Hereinafter, the storage class memory is also referred to as a storage class memory (SCM). The SCM is accessible on a byte-by-byte basis and at a higher speed than a conventional non-volatile memory.

Therefore, for example, as a main storage device of an arithmetic processing unit such as a central processing unit (CPU) mounted in a computer, it is considered to improve the performance of the computer by using a non-volatile memory and a volatile memory such as a DRAM in combination. Data transfer between the main storage device including the non-volatile memory and the arithmetic processing unit is controlled by the memory controller.

Here, for example, in a computer architecture which is not supposed to use a non-volatile memory as a main storage device, there is no mechanism for restricting the order of writing data in the non-volatile memory. Therefore, there is a possibility that the order of writing data in the non-volatile memory is changed in the memory controller. For example, in a case where the computer executes a program that operates properly by restricting the order of writing data to the main storage device, the program does not operate properly when the order of writing data of which writing order is restricted to the non-volatile memory is changed. In addition, for example, in a case where the computer crashes during execution of a writing process in which the order of data to be written to the non-volatile memory is being changed, there is a possibility that correct data is not be written to the non-volatile memory.

For this reason, an architecture in which an instruction for restricting the order of writing data from the memory controller to the non-volatile memory is added has been studied. In this type of architecture, an arithmetic processing unit issues an instruction for restricting the order of writing data to the non-volatile memory, and then waits for transfer of data to be written in the main storage device to the memory controller until the data writing to the non-volatile memory is completed. When the wait time for data transfer from the arithmetic processing unit to the memory controller increases, the processing performance of the computer deteriorates. For example, as the wait time of the arithmetic processing unit increases, the processing time of the program by the arithmetic processing unit increases.

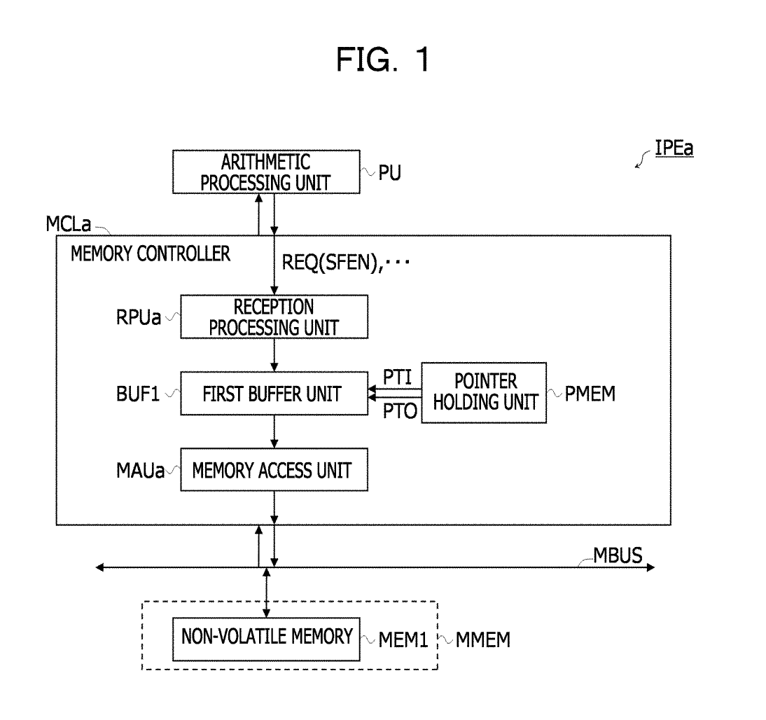

Hereinafter, embodiments will be described with reference to the drawings. FIG. 1 is a diagram illustrating one embodiment of a memory controller and a memory access method. A memory controller MCLa depicted in FIG. 1 controls a memory unit MMEM including a non-volatile memory MEM1. The memory unit MMEM is a main storage device of an arithmetic processing unit PU such as a CPU. Hereinafter, the memory unit MMEM is also referred to as a main storage device MMEM. In other words, the non-volatile memory MEM1 is a non-volatile memory device (NVDIMM: Non-Volatile Dual In-line Memory Module) used as the main storage device of the arithmetic processing unit PU. For example, an information processing apparatus IPEa such as a computer includes the memory controller MCLa, the arithmetic processing unit PU and the main storage device MMEM. The memory controller MCLa is coupled to the non-volatile memory MEM1 via a bus MBUS and controls data transfer between the arithmetic processing unit PU and the non-volatile memory MEM1.

For example, the memory controller MCLa receives request information REQ including an instruction such as an instruction SFEN or the like from the arithmetic processing unit PU. The instruction SFEN is an order restricting instruction that instructs the restriction of the execution order of a write instruction for writing data to the main storage device MMEM and is one type of instruction called a memory barrier or memory fence. Hereinafter, the instruction SFEN is also referred to as the instruction SFEN. For example, the arithmetic processing unit PU issues a fence instruction SFEN, and then stops issuing a write instruction until the arithmetic processing unit PU receives completion information indicating completion of the process based on the fence instruction SFEN. The operation of the memory controller MCLa in a case where the request information REQ including the fence instruction SFEN is received from the arithmetic processing unit PU will be described when explaining an operation of a reception processing unit RPUa which will be described later.

In a case where the arithmetic processing unit PU issues a write instruction, the memory controller MCLa receives request information REQ including the write instruction, data to be written, and an address from the arithmetic processing unit PU. Then, the memory controller MCLa writes the data included in the request information REQ to the main storage device MMEM based on the “write instruction” and the address included in the request information REQ received from the he arithmetic processing unit PU. The address is, for example, a physical address indicating a storage area of the main storage device MMEM.

In addition, in a case where the arithmetic processing unit PU issues a read instruction for reading data from the main storage device MMEM, the memory controller MCLa receives request information REQ including a read instruction and an address from the arithmetic processing unit PU. Then, the memory controller MCLa reads data to be read from the main storage device MMEM and outputs the read data to the arithmetic processing unit PU based on the read instruction and the address included in the request information REQ received from the processing unit PU.

The memory controller MCLa includes a first buffer unit BUF1, a pointer holding unit PMEM, the reception processing unit RPUa, and a memory access unit MAUa. Hereinafter, the first buffer unit BUF1 is also referred to as a buffer unit BUF1.

The buffer unit BUF1 is, for example, a non-volatile buffer that holds the request information REQ including data to be written to the non-volatile memory MEM1 among the request information REQ transferred from the arithmetic processing unit PU. That is, the buffer unit BUF1 holds data to be written to the non-volatile memory MEM1.

The pointer holding unit PMEM is a non-volatile memory that holds a pointer PT (PTI, PTO) used for accessing the buffer unit BUF1. A pointer PTI is an input pointer indicating a storing position of data to be stored in the buffer unit BUF1. A pointer PTO is an output pointer indicating a reading position of data to be read from the buffer unit BUF1.

The reception processing unit RPUa receives request information REQ from the arithmetic processing unit PU. For example, in a case where request information REQ including data to be written to the non-volatile memory MEM1 is received from the arithmetic processing unit PU, the reception processing unit RPUa stores the request information REQ received from the arithmetic processing unit PU in a buffer unit BUF1 by referring to the input pointer PTI. In this way, when storing the data to be written in the non-volatile memory MEM1 in the buffer unit BUF1, the reception processing unit RPUa stores the data in the storing position indicated by the input pointer PTI. The input pointer PTI is updated, for example, after the request information REQ is stored in the buffer unit BUF1.

In addition, in a case where the fence instruction SFEN is received from the arithmetic processing unit PU, the reception processing unit RPUa determines whether or not the preceding data transferred from the arithmetic processing unit PU before the fence instruction SFEN is stored in the buffer unit BUF1. Then, in a case where storing of the preceding data in the buffer unit BUF1 is completed, the reception processing unit RPUa notifies the arithmetic processing unit PU of completion information indicating that the process of restricting the execution order of the write instruction instructed by the fence instruction SFEN has been completed. Accordingly, the arithmetic processing unit PU resumes issuing a write instruction. Hereinafter, notifying the arithmetic processing unit PU of completion information indicating that the process of restricting the execution order of the write instruction instructed by the fence instruction SFEN has been completed is also referred to as releasing the fence instruction SFEN.

The memory access unit MAUa reads the data stored in the buffer unit BUF1 from the reading position indicated by an output pointer PTO and writes the data read from the buffer unit BUF1 to the non-volatile memory MEM1. For example, the memory access unit MAUa specifies a reading position of request information REQ including data and the like by referring to the output pointer PTO, and reads the request information REQ from the reading position specified by the buffer unit BUF1. Then, the memory access unit MAUa issues an instruction to the non-volatile memory MEM1 based on the request information REQ read from the buffer unit BUF1, and writes data included in the request information REQ in the non-volatile memory MEM1. The output pointer PTO is updated, for example, after data included in the request information REQ is written to the non-volatile memory MEM1.

That is, after the data is written to the non-volatile memory MEM1, the next data is read from the buffer unit BUF1. Therefore, writing of data to the non-volatile memory MEM1 is executed in the order that data is stored in the buffer unit BUF1. Accordingly, even if the fence instruction SFEN is released in a case where storing of the preceding data preceding the fence instruction SFEN in the buffer unit BUF1 is completed, writing of data to the non-volatile memory MEM1 is executed in the order that data is received from the arithmetic processing unit PU.

In this way, the memory controller MCLa releases the fence instruction SFEN in a case where storing of the preceding data preceding the fence instruction SFEN in the buffer unit BUF1 is completed. Therefore, the memory controller MCLa may quickly resume issuing a write instruction compared with the configuration in which issuing a write instruction is waited until writing of the preceding data to the non-volatile memory MEM1 is completed. As a result, it is possible to reduce waiting time for data transfer from the arithmetic processing unit PU to the memory controller MCLa. Accordingly, the memory controller MCLa may suppress an increase in process time of the program by the arithmetic processing unit PU. The configuration of the memory controller MCLa is not limited to the example depicted in FIG. 1.

In the embodiment depicted in FIG. 1, the nonvolatile buffer unit BUF1 holds data to be written to the non-volatile memory MEM1, the non-volatile pointer holding unit PMEM holds the input pointer PTI and the output pointer PTO of the buffer unit BUF1. Then, in a case where data to be written to the non-volatile memory MEM1 is received from the arithmetic processing unit PU, the reception processing unit RPUa stores the data received from the arithmetic processing unit PU in the storing position indicated by the input pointer PTI in the buffer unit BUF1. In addition, in a case where the fence instruction SFEN is received from the arithmetic processing unit PU, the reception processing unit RPUa determines whether or not the preceding data preceding the fence instruction SFEN is stored in the buffer unit BUF1. Then, in a case where storing of the preceding data in the buffer unit BUF1 is completed, the reception processing unit RPUa notifies the arithmetic processing unit PU of completion information indicating that the process of restricting the execution order of the write instruction instructed by the fence instruction SFEN has been completed.

In this way, the memory controller MCLa executes the releasing of the fence instruction SFEN without waiting until the writing of the preceding data to the non-volatile memory MEM1 is completed. Therefore, in the memory controller MCLa, it is possible to shorten waiting time until the arithmetic processing unit PU resumes issuing a write instruction and the like compared with the configuration in which the fence instruction SFEN is released in a case where the writing of the preceding data to the non-volatile memory MEM1 is completed. That is, the memory controller MCLa may suppress an increase in waiting time for data transfer from the arithmetic processing unit PU to the memory controller MCLa.

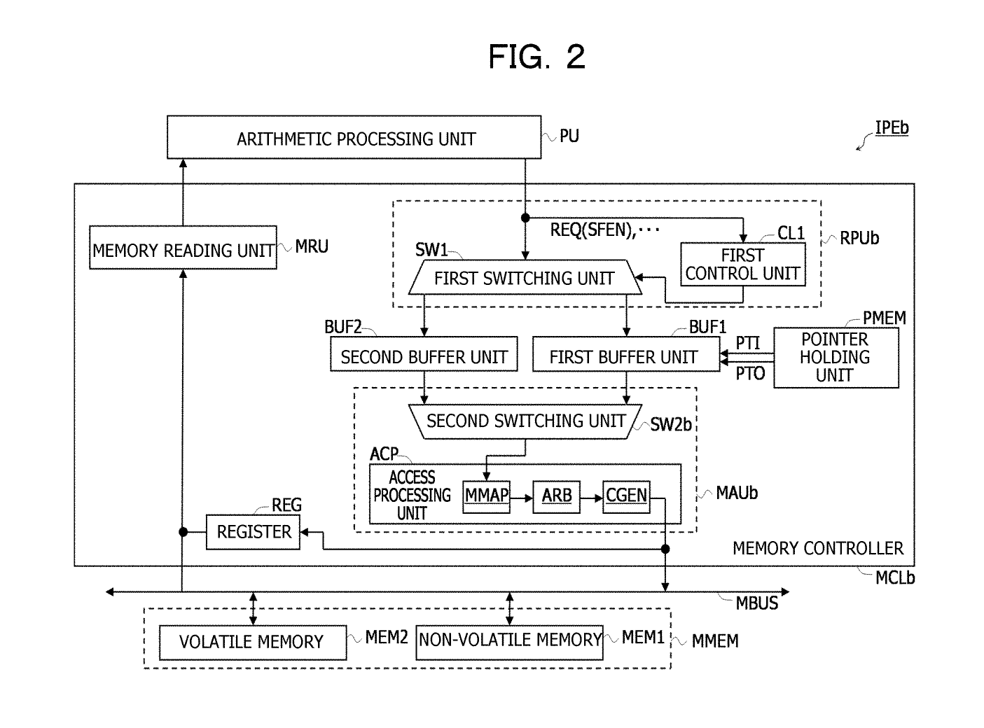

FIG. 2 is a diagram illustrating another embodiment of the memory controller and the memory access method. Elements that are the same as or similar to those described in FIG. 1 are denoted by the same or similar reference numerals, and a detailed description thereof will be omitted. A memory controller MCLb depicted in FIG. 2 controls the main storage device MMEM including the non-volatile memory MEM1 and a volatile memory MEM2. For example, the memory controller MCLb includes a reception processing unit RPUb and a memory access unit MAUb instead of the reception processing unit RPUa and the memory access unit MAUa depicted in FIG. 1. Further, in the memory controller MCLb, a second buffer unit BUF2, a register REG, and a memory reading unit MRU are added to a memory controller MCLa depicted in FIG. 1. The other configurations of the memory controller MCLb are the same as or similar to that of the memory controller MCLa depicted in FIG. 1. For example, an information processing apparatus IPEb includes the memory controller MCLb, the arithmetic processing unit PU and the main storage device MMEM. The memory controller MCLb is coupled to the non-volatile memory MEM1 and the volatile memory MEM2 via the bus MBUS, and controls data transfer between the main storage device MMEM including the non-volatile memory MEM1 and the volatile memory MEM2 and the arithmetic processing unit PU.

The memory controller MCLb includes the first buffer unit BUF1, the second buffer unit BUF2, the pointer holding unit PMEM, the reception processing unit RPUb, the memory access unit MAUb, the register REG, and the memory reading unit MRU. Hereinafter, the second buffer unit BUF2 is also referred to as a buffer unit BUF2.

The buffer unit BUF1 is the same as or similar to the buffer unit BUF1 depicted in FIG. 1. For example, the buffer unit BUF1 is a non-volatile buffer that holds data to be written to the non-volatile memory MEM1 among the data transferred from the arithmetic processing unit PU.

The buffer unit BUF2 is, for example, a volatile buffer that holds the request information REQ not held in the first buffer unit BUF1 among the request information REQ transferred from the arithmetic processing unit PU. For example, the second buffer unit BUF2 holds data to be written to the volatile memory MEM2 among the data transferred from the arithmetic processing unit PU.

The reception processing unit RPUb includes a first switch unit SW1 and a first control unit CL1. Hereinafter, the first switch unit SW1 and the first control unit CL1 are also referred to as a switch unit SW1 and a control unit CL1.

The switch unit SW1 outputs data to one of the buffer units BUF1 and BUF2 corresponding to the memory to which the data received from the arithmetic processing unit PU is written. In the switch unit SW1, the output destination of data is set to one of the buffer units BUF1 and BUF2 according to the destination of data received from the arithmetic processing unit PU under the control of the control unit CL1. For example, in a case where the output destination is set to the buffer unit BUF1, the switch unit SW1 stores the request information REQ received from the arithmetic processing unit PU in the storing position indicated by the input pointer PTI. Accordingly, the data contained in the request information REQ is stored in the storing position indicated by the input pointer PTI. Then, for example, the switch unit SW1 updates the input pointer PTI after storing the request information REQ in the buffer unit BUF1. In addition, in a case where the output destination is set to the buffer unit BUF2, the switch unit SW1 stores the request information REQ received from the arithmetic processing unit PU in the buffer unit BUF2.

The control unit CL1 receives an instruction and an address among the information included in the request information REQ transferred from the arithmetic processing unit PU to the switch unit SW1. Then, in a case where the control unit CL1 receives a write instruction for writing data to the non-volatile memory MEM1 from the arithmetic processing unit PU, the control unit CL1 sets the output destination of the switch unit SW1 to the buffer unit BUF1. For example, in a case where the address received from the arithmetic processing unit PU is an address assigned to the non-volatile memory MEM1 and the instruction received from the arithmetic processing unit PU is a write instruction, the control unit CL1 sets the output destination of the switch unit SW1 to the buffer unit BUF1. In a case where the address received from the arithmetic processing unit PU is an address of the volatile memory MEM2 or the instruction received from the arithmetic processing unit PU is other than a write instruction, the control unit CL1 sets the output destination of the switch unit SW1 in the buffer unit BUF2.

In addition, in a case where the fence instruction SFEN is received from the arithmetic processing unit PU, the control unit CL1 determines whether or not the preceding data preceding the fence instruction SFEN is stored in one of the buffer units BUF1 and BUF2. Then, in a case where storing of the preceding data in one of the buffer units BUF1 and BUF2 is completed, the control unit CL1 notifies the arithmetic processing unit PU of completion information indicating that the process of restricting the execution order of the write instruction instructed by the fence instruction SFEN has been completed. The pointer holding unit PMEM is the same as or similar to the pointer holding unit PMEM depicted in FIG. 1.

The memory access unit MAUb includes a second switch unit SW2b and an access processing unit ACP. Hereinafter, the second switch unit SW2b is also referred to as a switch unit SW2b. In a case where the switch unit SW2b is set to be the first state where the buffer unit BUF1 is accessible, the switch unit SW2b reads the data stored in the buffer unit BUF1 from the reading position indicated by the output pointer PTO. In addition, in a case where the switch unit SW2b is set to the second state where the buffer unit BUF2 is accessible, the switch unit SW2b reads the data stored in the buffer unit BUF2. For example, the switch unit SW2b alternately selects a first state and a second state for each access.

The access processing unit ACP writes the data transferred from the buffer unit BUF1 via the switch unit SW2b to the non-volatile memory MEM1, and writes the data transferred from the buffer unit BUF2 via the switch unit SW2b to the volatile memory MEM2. For example, the access processing unit ACP includes a memory mapping unit MMAP, an arbitration unit ARB, and a command generating unit CGEN.

The memory mapping unit MMAP converts the address transferred from the arithmetic processing unit PU via the switch unit SW2b or the like to an address of a memory to be accessed out of the non-volatile memory MEM1 and the volatile memory MEM2. For example, the memory mapping unit MMAP converts the address read from the buffer unit BUF1 to an address of the non-volatile memory MEM1, and converts the address read from the buffer unit BUF2 to an address of the volatile memory MEM2. The arbitration unit ARB executes scheduling of instructions transferred from the arithmetic processing unit PU via the switch unit SW2b or the like.

The command generating unit CGEN converts an instruction transferred from the arithmetic processing unit PU via the arbitration unit ARB or the like to an instruction of a memory to be accessed out of the non-volatile memory MEM1 and the volatile memory MEM2, and outputs the converted instruction to the memory of the access destination. For example, the command generating unit CGEN converts the instruction read from the buffer unit BUF1 to an instruction of the non-volatile memory MEM1, and converts the instruction read from the buffer unit BUF2 to an address of the volatile memory MEM2.

The memory reading unit MRU receives data to be read requested by a read instruction from the main storage device MMEM or the like, and transfers the received data to the arithmetic processing unit PU. That is, the memory reading unit MRU receives data from the non-volatile memory MEM1 and the volatile memory MEM2, and transfers the received data to the arithmetic processing unit PU.

The register REG sequentially holds data and the like output from the access processing unit ACP. Accordingly, the memory controller MCLb may transfer data to be read from the register REG to the memory reading unit MRU even while the data to be read requested by a read instruction is being written to the main storage device MMEM (in the state where writing is not completed). The configuration of the memory controller MCLb is not limited to the example depicted in FIG. 2.

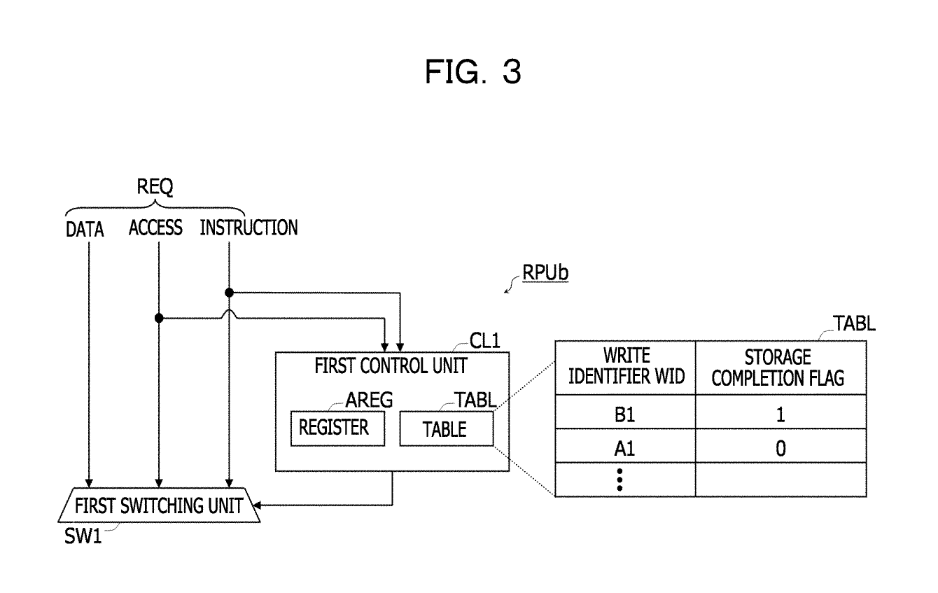

FIG. 3 illustrates an example of the reception processing unit RPUb depicted in FIG. 2. The configuration of the reception processing unit RPUb is not limited to the example depicted in FIG. 3.

the reception processing unit RPUb includes the switch unit SW1 and the control unit CL1 as described in FIG. 2. The switch unit SW1 receives the request information REQ including data, an address, an instruction, and the like. The request information REQ may not include data or the like depending on the type of the instruction. In addition, a write instruction includes, for example, a flag for the fence instruction SFEN indicating that the write instruction is a target of the fence instruction SFEN. For example, for a write instruction that is a target of the fence instruction SFEN, the flag for the fence instruction SFEN is set to a logical value “1”.

The control unit CL1 includes, for example, a register AREG for storing an address assigned to the non-volatile memory MEM1 and a table TABL for the fence instruction SFEN. The table TABL sets a write identifier WID for identifying a write instruction and a logical value “1” and a storage completion flag SFLG to be set to a logical value “1” in a case where data to be written requested by a write instruction is stored in the buffer unit BUF1. Hereinafter, the write identifier WID and the storage completion flag SFLG are also referred to as an identifier WID and a flag SFLG.

The control unit CL1 receives an address and an instruction among the information included in the request information REQ received by the switch unit SW1. For example, the control unit CL1 compares the address received from the arithmetic processing unit PU with the address stored in the register AREG, and determines whether or not the address received from the arithmetic processing unit PU is an address assigned to the non-volatile memory MEM1. In addition, the control unit CL1 determines whether or not the instruction received from the arithmetic processing unit PU is a write instruction. Then, in a case where the address received from the arithmetic processing unit PU is an address assigned to the non-volatile memory MEM1 and the instruction received from the arithmetic processing unit PU is a write instruction, the control unit CL1 sets the output destination of the switch unit SW1 to the buffer unit BUF1. In the initial state, the output destination of the switch unit SW1 is set, for example, in the buffer unit BUF2.

In addition, in a case where the control unit CL1 receives a write instruction where a flag for the fence instruction SFEN is set to a logical value “1”, the control unit CL1 registers the received instruction in the table TABL. Accordingly, the identifier WID of the write instruction to be a target of the fence instruction SFEN is stored in the table TABL and a flag SFLG corresponding to the identifier WID is reset to a logical value “0”. Then, in a case where storing data to be written requested by a write instruction to one of the buffer units BUF1 and BUF2 is completed, the control unit CL1 sets the flag SFLG corresponding to the stored write instruction whose storing has been completed to a logical value “1”.

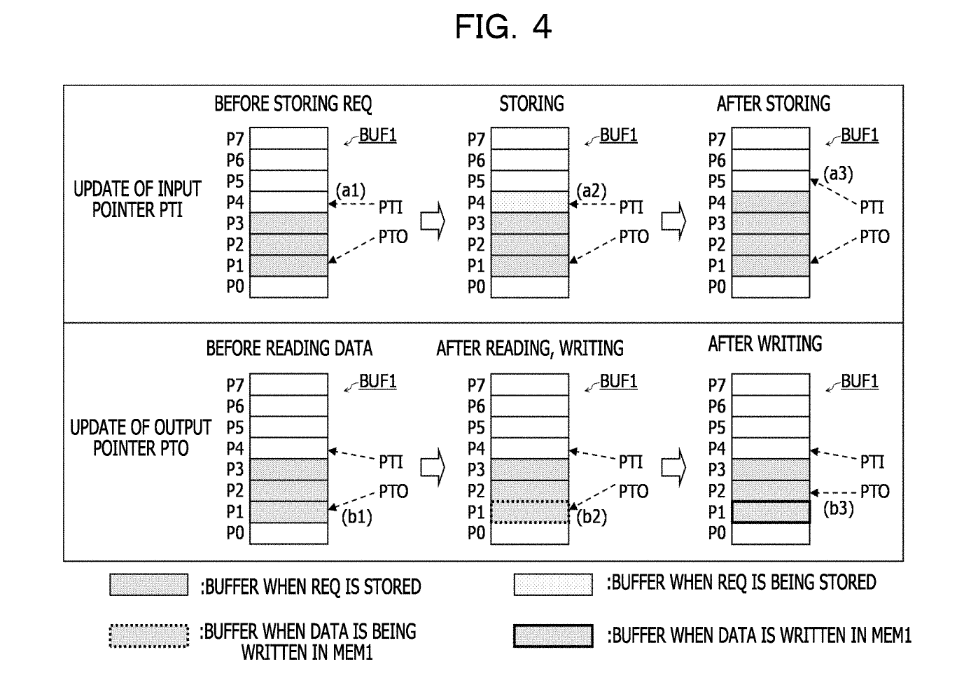

FIG. 4 illustrates an example of updating the pointers PTI and PTO depicted in FIG. 2. The codes P (P0-P7) depicted in FIG. 4 indicate positions of storing areas in the buffer unit BUF1. The dark shaded storing area depicted in FIG. 4 indicates that the request information REQ has been stored and the light shaded storing area indicates that the request information REQ is being stored. In addition, the thick framed storing area depicted in FIG. 4 indicates that data has been written to the non-volatile memory MEM1, and the storage area surrounded by the broken line indicates that data is being written to the non-volatile memory MEM1. First, updating of the input pointer PTI will be described.

Before the request information REQ received from the arithmetic processing unit PU is stored in the buffer unit BUF1, the input pointer PTI indicates a position P4 as the storing position ((a1) of FIG. 4). Therefore, the switch unit SW1 stores the request information REQ received from the arithmetic processing unit PU in the position P4 indicated by the input pointer PTI. Even if storing of the request information REQ to the buffer unit BUF1 is started, the input pointer PTI is not updated until storing of the request information REQ to the buffer unit BUF1 is completed. Therefore, while the request information REQ is being stored, the storing position indicated by the input pointer PTI is maintained at the position P4 ((a2) of FIG. 4). After storing the request information REQ to the buffer unit BUF1 is completed, the storing position indicated by the input pointer PTI is updated to a position P5 ((a3) of FIG. 4). By keeping this order and updating the input pointer PTI, consistency of the order in writing data to the non-volatile memory MEM1 is maintained. Next, updating of the output pointer PTO will be described.

Before reading the data received from the arithmetic processing unit PU from the buffer unit BUF1, the output pointer PTO indicates a position P1 as the reading position ((b1) in FIG. 4). Therefore, the switch unit SW2b reads data to be written to the non-volatile memory MEM1 from a position P1 indicated by the output pointer PTO. Even if data is read from the buffer unit BUF1, the output pointer PTO is not updated until the writing of data to the non-volatile memory MEM1 is completed. Therefore, while data is being written to the non-volatile memory MEM1, the reading position indicated by the output pointer PTO is maintained at the position P1 ((b2) of FIG. 4). After writing of data to the non-volatile memory MEM 1 is completed, the reading position indicated by the output pointer PTO is updated to a position P2 ((b3) of FIG. 4). By keeping this order and updating the output pointer PTO, consistency of the order in writing data to the non-volatile memory MEM1 is maintained. That is, the memory controller MCLb ensures the consistency of the order in writing data to the non-volatile memory MEM1 by executing updating of the input pointer PTI and the output pointer PTO in the order depicted in FIG. 4.

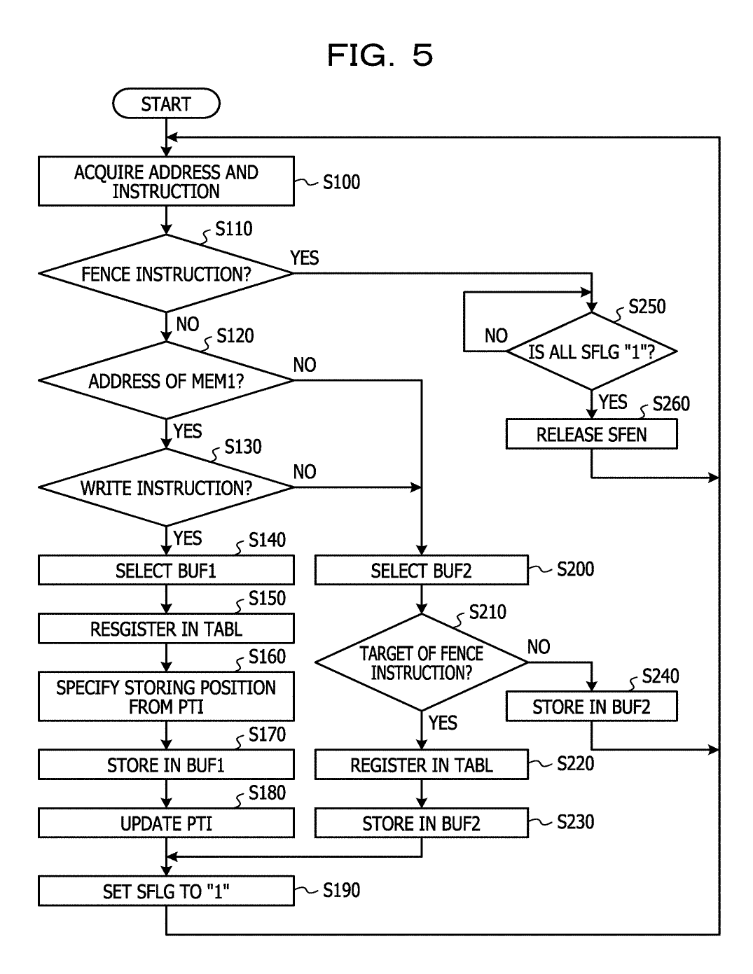

FIG. 5 illustrates an example of an operation of the first control unit CL1 and the first switch unit SW1 depicted in FIG. 2. The operation depicted in FIG. 5 is an operation of the memory controller MCLb when storing the request information REQ in one of the buffer units BUF1 and BUF2. In addition, in the example depicted in FIG. 5, a write instruction for writing data to the non-volatile memory MEM1 is transferred from the arithmetic processing unit PU to the memory controller MCLb with the flag for the fence instruction SFEN set to a logical value “1”.

In step S100, the switch unit SW1 receives the request information REQ from the arithmetic processing unit PU, and the control unit CL 1 acquires an address and an instruction from the information included in the request information REQ received by the switch unit SW1.

Next, in step S110, the control unit CL1 determines whether or not the command acquired in step S100 is the fence instruction SFEN. In a case where the instruction acquired in step S100 is the fence instruction SFEN, the operation of the memory controller MCLb proceeds to step S250. On the other hand, in a case where the instruction acquired in step S100 is not the fence instruction SFEN, the operation of the memory controller MCLb proceeds to step S120.

In step S120, the control unit CL1 determines whether or not the address acquired in step S100 is an address assigned to the non-volatile memory MEM1. In a case where the address acquired in step S100 is an address allocated to the non-volatile memory MEM1, the operation of the memory controller MCLb proceeds to step S130. On the other hand, in a case where the address acquired in step S100 is not an address allocated to the non-volatile memory MEM1, the operation of the memory controller MCLb proceeds to step S200.

In step S130, the control unit CL1 determines whether or not the instruction acquired in step S100 is a write instruction. In a case where the instruction acquired in step S100 is a write instruction, the operation of the memory controller MCLb proceeds to step S140. On the other hand, in a case where the instruction acquired in step S100 is not a write instruction, the operation of the memory controller MCLb proceeds to step S200.

In step S140, the control unit CL1 selects the buffer unit BUF1 as the output destination of the switch unit SW1. That is, the control unit CL1 sets the output destination of the switch unit SW1 in the buffer unit BUF1.

Next, in step S150, the control unit CL1 registers the instruction acquired in step S100 in the table TABL.

Next, in step S160, the switch unit SW1 refers to the input pointer PTI to specify a storing position.

Next, in step S170, the switch unit SW1 stores the request information REQ received from the arithmetic processing unit PU in the storing position indicated by the input pointer PTI in the storing area of the buffer unit BUF1. That is, the switch unit SW1 stores the request information REQ received in step S100 in the storing position specified in step S 160. After the storing of the request information REQ to the buffer unit BUF1 is completed, the process of step S180 is executed.

In step S180, the switch unit SW1 updates the input pointer PTI. In this way, the switch unit SW1 updates the input pointer PTI after storing the request information REQ in the buffer unit BUF1. After the process of step S180 is executed, the operation of the memory controller MCLb precedes to step S190.

In step S190, the control unit CL1 sets the flag SFLG corresponding to a write instruction for which storing data in one of the buffer units BUF1 and BUF2 has been completed to a logical value “1”. For example, in a case where the operation of the memory controller MCLb proceeds to step S190 via step S170, the control unit CL1 sets the flag SFLG corresponding to the write instruction registered in the table TABL in a step S 150 to a logical value “1”. In addition, in a case where the operation of the memory controller MCLb proceeds to step S190 via step S230 to be described later, the control unit CL1 sets the flag SFLG corresponding to the write instruction registered in the table TABL in step S220, which will be described later, to a logical value Set to “1”. The updating of the flag SFLG may be executed by the switch unit SW1. After the process of step S190 is executed, the operation of the memory controller MCLb returns to step S100.

In step S200, the control unit CL1 selects the buffer unit BUF2 as the output destination of the switch unit SW1. That is, the control unit CL1 sets the output destination of the switch unit SW1 in the buffer unit BUF2.

Next, in step S210, the control unit CL1 determines whether or not the instruction acquired in step S100 is a target of the fence instruction SFEN. For example, it is determined whether or not the flag for the fence instruction SFEN included in the instruction acquired in step S100 is set to a logical value “1”. In a case where the instruction acquired in step S100 is a target of the fence instruction SFEN, the operation of the memory controller MCLb proceeds to step S220. On the other hand, in a case where the instruction acquired in step S100 is not a target of the fence instruction SFEN, the operation of the memory controller MCLb proceeds to step S240.

In step S220, the control unit CL1 registers the instruction acquired in step S100 in the table TABL.

In step S230, the switch unit SW1 stores the request information REQ received from the arithmetic processing unit PU in the buffer unit BUF2. That is, the switch unit SW1 stores the request information REQ received in step S100 in the buffer unit BUF2. After the process of step S230 is executed and storing of the request information REQ to the buffer unit BUF2 is completed, the operation of the memory controller MCLb proceeds to step S190.

In step S240, the switch unit SW1 stores the request information REQ received from the arithmetic processing unit PU in the buffer unit BUF2. That is, the switch unit SW1 stores the request information REQ received in step S100 in the buffer unit BUF2. After the process of step S240 is executed, the operation of the memory controller MCLb returns to step S100.

In step S250, the control unit CL1 determines whether or not the flag SFLG corresponding to the write instruction registered in the table TABL in steps S150, S220, and the like has all been set to a logical value “1”. That is, the control unit CL1 determines whether or not all the data to be a target of the fence instruction SFEN among the data received before receiving the fence instruction SFEN, has been stored in one of the buffer units BUF1 and BUF2. In a case where all the flags SFLG to be determined are set to a logical value “1”, the operation of the memory controller MCLb proceeds to step S260.

On the other hand, in a case where any of the flags SFLG to be determined is not set to a logical value “1”, that is, in a case where any of the flags SFLG to be determined is a logical value “0”, the operation of the memory controller MCLb returned to step S250. That is, the memory controller MCLb waits without executing the process of step S260 until all the flags SFLG to be determined are set to a logical value “1”.

In step S260, the control unit CL1 releases the fence instruction SFEN. For example, the control unit CL1 notifies the arithmetic processing unit PU of completion information indicating that the process of restricting the execution order of the write instruction instructed by the fence instruction SFEN has been completed. Accordingly, the arithmetic processing unit PU resumes issuing a write instruction that is stopped based on the fence instruction SFEN. After the process of step S260 is executed, the operation of the memory controller MCLb returns to step S100.

In this way, in a case where the fence instruction SFEN is received from the arithmetic processing unit PU, the memory controller MCLb determines whether or not all the preceding data to be a target of the fence instruction SFEN is stored in one of the buffer units BUF1 and BUF2. Then, the memory controller MCLb releases the fence instruction SFEN in a case where all the preceding data to be a target of the fence instruction SFEN is stored in any of the buffer units BUF1 and BUF2. The operations of the control unit CL1 and the switch unit SW1 are not limited to the example depicted in FIG. 5.

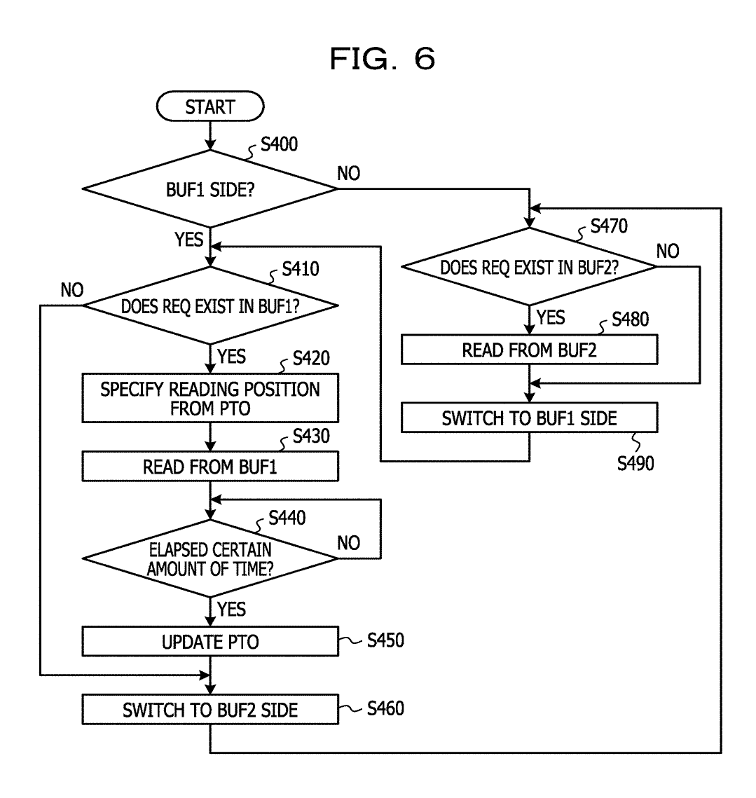

FIG. 6 is a diagram illustrating an example of an operation of the second switch unit SW2b depicted in FIG. 2. The operation depicted in FIG. 6 is an operation of the memory controller MCLb when the request information REQ from one of the buffer units BUF1 and BUF2 is read.

In step S400, it is determined whether or not the switch unit SW2b is set to a first state where the buffer unit BUF1 is accessible. In a case where the switch unit SW2b is set to the first state where the buffer unit BUF1 is accessible, the operation of the memory controller MCLb proceeds to step S410. On the other hand, in a case where the switch unit SW2b is not set to the first state where the buffer unit BUF1 is accessible, that is, in a case where the switch unit SW2b is set to the second state where the buffer unit BUF2 is accessible, the operation of the memory controller MCLb proceeds to step S470.

In step S410, the switch unit SW2b determines whether or not the request information REQ that has not been read exists in the buffer unit BUF1. For example, the switch unit SW2b determines whether or not the input pointer PTI and the output pointer PTO indicate the same position. In a case where the input pointer PTI and the output pointer PTO indicate the same position, the switch unit SW2b determines that data to be written to the non-volatile memory MEM1 does not exist in the buffer unit BUF1. That is, in a case where the input pointer PTI and the output pointer PTO indicate different positions, the switch unit SW2b determines that the request information REQ including data to be written to the non-volatile memory MEM1 exists in the buffer unit BUF1.

In a case where the request information REQ which has not been read exists in the buffer unit BUF1, the operation of the memory controller MCLb proceeds to step S420. On the other hand, in a case where the request information REQ which has not been read does not exist in the buffer unit BUF1, the operation of the memory controller MCLb proceeds to step S460.

In step S420, the switch unit SW2b refers to the output pointer PTO to specify a reading position.

Next, in step S430, the switch unit SW2b reads the request information REQ stored in the buffer unit BUF1 from the reading position specified in step S420. In this way, in a case where the switch unit SW2b is set to the first state where the buffer unit BUF1 is accessible, the switch unit SW2b reads the data stored in the buffer unit BUF1 from the reading position indicated by the output pointer PTO.

The request information REQ read from the buffer unit BUF1 by the switch unit SW2b is transferred to the access processing unit ACP. Then, the access processing unit ACP writes data included in the request information REQ transferred from the buffer unit BUF1 via the switch unit SW2b to the non-volatile memory MEM1.

Next, in step S440, the switch unit SW2b determines whether or not a certain amount of time has elapsed. The certain amount of time is, for example, the time from when data is read from the buffer unit BUF1 to when data writing to the non-volatile memory MEM1 is completed. In a case where the certain amount of time has not elapsed, the operation of the memory controller MCLb precedes to step S450. On the other hand, in a case where the certain amount of time has not elapsed, the operation of the memory controller MCLb returns to step S440. That is, the process of step S450 is waited until the writing of data read from the buffer unit BUF1 to the non-volatile memory MEM1 is completed in step S430.

In step S450, the switch unit SW2b updates the output pointer PTO. In this way, the switch unit SW2b updates the output pointer PTO after data included in the request information REQ is written to the non-volatile memory MEM1. After the process of step S450 is executed, the operation of the memory controller MCLb precedes to step S460.

In step S460, the switch unit SW2b is switched to the second state where the buffer unit BUF2 is accessible. After the process of step S460 is executed, the operation of the memory controller MCLb precedes to step S470.

In step S470, the switch unit SW2b determines whether or not the request information REQ that has not been read exists in the buffer unit BUF2. In a case where the request information REQ which has not been read exists in the buffer unit BUF2, the operation of the memory controller MCLb proceeds to step S480. On the other hand, in a case where the request information REQ which has not been read does not exist in the buffer unit BUF2, the operation of the memory controller MCLb proceeds to step S490.

In step S480, the switch unit SW2b reads the request information REQ stored in the buffer unit BUF2. In this way, the switch unit SW2b reads the data stored in the buffer unit BUF2 in a case where the switch unit SW2b is set to the second state where the buffer unit BUF2 is accessible. The request information REQ read from the buffer unit BUF2 by the switch unit SW2b is transferred to the access processing unit ACP.

In step S490, the switch unit SW2b is switched to the first state where the buffer unit BUF1 is accessible. After the process of step S490 is executed, the operation of the memory controller MCLb returns to step S410.

In this way, the switch unit SW2b alternately selects the first state and the second state for every access. The operation of the switch unit SW2b is not limited to the example depicted in FIG. 6.

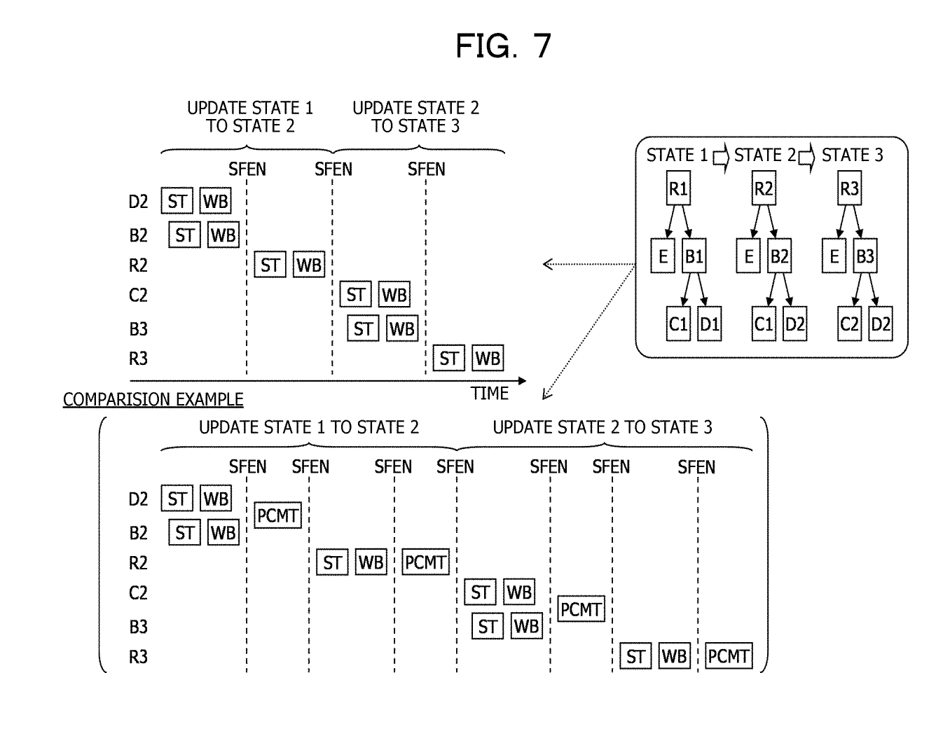

FIG. 7 illustrates an example of data update by the information processing apparatus IPEb in which the memory controller MCLb depicted in FIG. 2 is mounted. In addition, a comparison example is illustrated in the parentheses in FIG. 7. The comparison example depicted in FIG. 7 illustrates an operation of the information processing apparatus in a case where an architecture including an instruction PCMT for restricting the order of writing data from the memory controller to the non-volatile memory MEM1 is adopted. An instruction ST is a store instruction for storing data in the memory and an instruction WB is a write back instruction for writing back the data stored in the cache memory in the arithmetic processing unit PU to the main storage device MMEM. The instruction ST and the like are issued from the CPU core in the arithmetic processing unit PU.

The operation depicted in FIG. 7 is an operation of the information processing apparatus IPEb when updating the tree-structured data from a state 1 to a state 2 and updating from the state 2 to a state 3. Symbols R (R1, R2, and R3) depicted in FIG. 7 indicate route points. In addition, symbols B (B1, B2, and B3), C (C1 and C2), D (D1 and D2), E depicted in FIG. 7 indicate data structures. Hereinafter, a route point R, data structures B, C, D, E are also referred to as data R, B, C, D, and E.

First, the store instruction ST is issued from the CPU core in the arithmetic processing unit PU, and data D2 is stored in the cache memory in the arithmetic processing unit PU. The write back instruction WB is issued from the CPU core, and the data D2 stored in the cache memory is transferred to the memory controller MCLb. Similarly, the store instruction ST and the write back instruction WB are sequentially issued from the CPU core, and the data B2 is stored in the cache memory, and data B2 stored in the cache memory is transferred to the memory controller MCLb. Then, the fence instruction SFEN is issued from the CPU core to the memory controller MCLb to ensure that the data D2 and B2 reach the memory controller MCLb. The memory controller MCLb stores the data D2 and B2 in the buffer unit BUF1, and then releases the fence instruction SFEN.

After the fence instruction SFEN is released, the store instruction ST and the write back instruction WB are sequentially issued from the CPU core, and the data R2 is stored in the cache memory, and data R2 stored in the cache memory is transferred to the memory controller MCLb. Then, the fence instruction SFEN is issued from the CPU core to the memory controller MCLb to ensure that the data R2 reaches the memory controller MCLb, and after the data R2 is stored in the buffer unit BUF1, the fence instruction SFEN is released. Accordingly, the process of updating the tree-structured data from the state 1 to the state 2 is ended, and the process of updating the tree-structured data from the state 2 to the state 3 is executed.

In contrast, in the comparison example, after the fence instruction SFEN is issued from the CPU core to the memory controller MCLb to ensure that the data D2 and B2 reach the memory controller MCLb, the instruction PCMT is issued. Then, in the comparison example, after the process based on the instruction PCMT is completed, the fence instruction SFEN is issued again to ensure that the data D2 and B2 are written to the non-volatile memory MEM1. After the fence instruction SFEN is issued, in order to update data R1 to the data R2, the instructions ST, WB, SFEN, PCMT, SFEN are sequentially issued in the same manner as the update of the data D2 and B2. Accordingly, the process of updating the tree-structured data from the state 1 to the state 2 is ended, and the process of updating the tree-structured data from the state 2 to the state 3 is executed. The CPU core that issues the instruction PCMT waits for the next writing to the memory controller until the writing of data into the non-volatile memory MEM1 is completed.

On the other hand, in the information processing apparatus IPEb in which the memory controller MCLb is mounted, the instruction PCMT may be omitted. Therefore, in the memory controller MCLb, compared to the comparative example, it is possible to shorten the waiting time until the arithmetic processing unit PU resumes issuing a write instruction and the like. That is, the memory controller MCLb may suppress an increase in waiting time for data transfer from the arithmetic processing unit PU to the memory controller MCLa. Accordingly, the memory controller MCLb may suppress the deterioration of the process performance of the arithmetic processing unit PU.

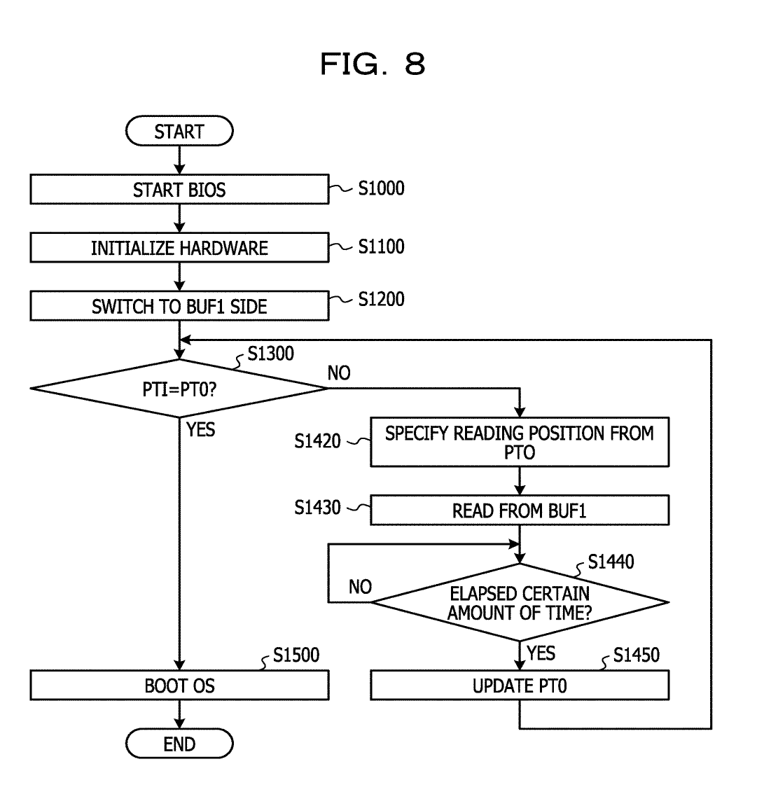

FIG. 8 illustrates an example of an operation of the information processing apparatus IPEb in which the memory controller MCLb depicted in FIG. 2 is mounted. FIG. 8 illustrates an example of a boot sequence of the information processing apparatus IPEb.

In step S1000, the information processing apparatus IPEb starts the basic input/output system (BIOS).

Next, in step S1100, the information processing apparatus IPEb initializes hardware such as the arithmetic processing unit PU and the memory controller MCLb. For example, the arithmetic processing unit PU executes an initialization process at power-on. In the initial state, the output destination of the switch unit SW1 is set in the buffer unit BUF2, and the switch unit SW2b is set to the second state where the buffer unit BUF2 is accessible. Accordingly, it is possible to avoid data in the non-volatile buffer unit BUF1 from being erased by initializing only the volatile buffer unit BUF2 in hardware initialization. In addition, it is possible to apply the initialization method of a conventional memory controller as it is.

Next, in step S1200, the memory controller MCLb switches the switch unit SW2b to the first state where the buffer unit BUF1 is accessible.

Next, in step S1300, the switch unit SW2b of the memory controller MCLb determines whether or not the input pointer PTI and the output pointer PTO indicate the same position. In a case where the input pointer PTI and the output pointer PTO indicate the same position, that is, in a case where data to be written to the non-volatile memory MEM1 does not exist in the buffer unit BUF1, the operation of the information processing apparatus IPEb proceeds to step S1500. On the other hand, in a case where the input pointer PTI and the output pointer PTO indicate different positions, that is, in a case where the request information REQ including data to be written to the non-volatile memory MEM1 exists in the buffer unit BUF1, the operation of the information processing apparatus IPEb proceeds to step S1420.

In this way, the switch unit SW2b compares the residual data remaining in the buffer unit BUF1 without being written to the non-volatile memory MEM1 in the previous operation before power shutdown exists based on the comparison result between the input pointer PTI and the output pointer PTO.

Steps S1420, S1430, S1440, and S1450 are the same as or similar to steps S420, S430, S440, and S450 depicted in FIG. 6. In steps S1420, S1430, S1440 and S1450, the switch unit SW2b transfers the residual data held in the buffer unit BUF1 to the access processing unit ACP. That is, in a case where the residual data is held in the buffer unit BUF1, the switch unit SW2b writes the residual data held in the buffer unit BUF1 to the non-volatile memory MEM1 via the access processing unit ACP. After the process of step S1450 is executed, the operation of the information processing apparatus IPEb returns to step S1300.

In step S1500, the information processing apparatus IPEb boots the Operating System (OS). In this way, in the case where the residual data is not held in the buffer unit BUF1, the information processing apparatus IPEb directly boots the OS after hardware initialization. In addition, in a case where the residual data is held in the buffer unit BUF1, the information processing apparatus IPEb writes the residual data held in the buffer unit BUF1 to the non-volatile memory MEM1, and then boots the OS. The operation of the information processing apparatus IPEb is not limited to the example depicted in FIG. 8.

As described above, in the embodiments depicted in FIGS. 2 to 8, the same effects as those of the embodiment depicted in FIG. 1 may be obtained. For example, in a case where the switch unit SW1 receives data to be written to the non-volatile memory MEM1 from the arithmetic processing unit PU, the reception processing unit RPUa stores the data received from the arithmetic processing unit PU in the storing position indicated by the input pointer PTI in the buffer unit BUF1. In addition, in a case where the fence instruction SFEN is received from the arithmetic processing unit PU, the control unit CL1 determines whether or not the preceding data preceding the fence instruction SFEN is stored in one of the buffer units BUF1 and BUF2. Then, in a case where storing of the preceding data in one of the buffer units BUF1 and BUF2 is completed, the control unit CL1 notifies the arithmetic processing unit PU of completion information indicating that the process of restricting the execution order of the write instruction instructed by the fence instruction SFEN has been completed.

In this way, the memory controller MCLb executes the releasing of the fence instruction SFEN without waiting until the writing of the preceding data to the non-volatile memory MEM1 is completed. As a result, it is possible to suppress an increase in waiting time for data transfer from the arithmetic processing unit PU to the memory controller MCLb.

Further, the memory controller MCLb includes the volatile buffer unit BUF2 for the volatile memory MEM2 in addition to the non-volatile buffer unit BUF1. Accordingly, even in a case where a plurality of preceding data preceding the data to be written to the volatile memory MEM2 is written in the non-volatile memory MEM1, the data may be written to the volatile memory MEM2 before all the preceding data is written in the non-volatile memory MEM1. As a result, it is possible to suppress an increase in data writing time from the memory controller MCLb to the main storage device MMEM.

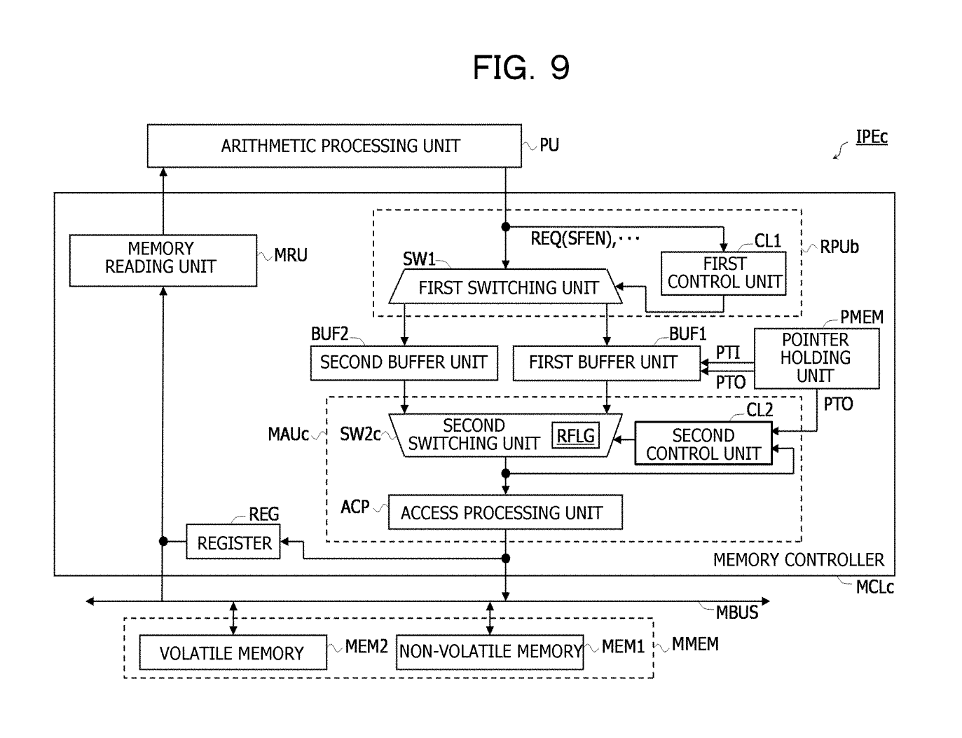

FIG. 9 is a diagram illustrating another embodiment of the memory controller and the memory access method. Elements that are the same as or similar to those described in FIGS. 1 to 8 are denoted by the same or similar reference numerals, and a detailed description thereof will be omitted. A memory controller MCLc depicted in FIG. 9 controls the main storage device MMEM including the non-volatile memory MEM1 and a volatile memory MEM2. For example, the memory controller MCLc is the same as or similar to the memory controller MCLb shown in FIG. 2, except that a memory controller MCLc includes a memory access unit MAUc instead of the memory access unit MAUb depicted in FIG. 2. For example, an information processing apparatus IPEc includes the memory controller MCLc, the arithmetic processing unit PU and the main storage device MMEM. The memory controller MCLc is coupled to the non-volatile memory MEM1 and the volatile memory MEM2 via the bus MBUS, and controls data transfer between the main storage device MMEM including the non-volatile memory MEM1 and the volatile memory MEM2 and the arithmetic processing unit PU.

The memory controller MCLc includes the first buffer unit BUF1, the second buffer unit BUF2, the pointer holding unit PMEM, the reception processing unit RPUb, the memory access unit MAUc, the register REG, and the memory reading unit MRU.

The buffer units BUF1 and BUF2, the reception processing unit RPUb, and the pointer holding unit PMEM are the same as or similar to the buffer units BUF1 and BUF2, the reception processing unit RPUb, and the pointer holding unit PMEM depicted in FIG. 2.

The memory access unit MAUc includes a second switch unit SW2c instead of the second switch unit SW2b depicted in FIG. 2. In addition, in the memory access unit MAUc, a second control unit CL2 is added to the memory access unit MAUb depicted in FIG. 2. The other configurations of the memory access unit MAUc are the same as or similar to that of the memory access unit MAUb depicted in FIG. 2. That is, the memory access unit MAUb includes the second switch unit SW2c, the second control unit CL2, and the access processing unit ACP. Hereinafter, the second switch unit SW2c and the second control unit CL2 are also referred to as a switch unit SW2c and a control unit CL2. In a case where the switch unit SW2c is set to the first state where the buffer unit BUF1 is accessible, the switch unit SW2c reads the data stored in the buffer unit BUF1 from the reading position indicated by the output pointer PTO. In addition, in a case where the switch unit SW2c is set to the second state where the buffer unit BUF2 is accessible, the switch unit SW2b reads the data stored in the buffer unit BUF2. For example, the switch unit SW2c includes a reading flag RFLG for the buffer unit BUF1 and is set to either the first state or the second state by the control unit CL2. Hereinafter, the reading flag RFLG is also referred to as a flag RFLG.

The control unit CL2 receives an instruction output from the switch unit SW2c and an address indicating a storing area of the main storage device MMEM. For example, in a case where the address and the instruction received from the switch unit SW2c are an address assigned to the non-volatile memory MEM1 and a write instruction, the control unit CL2 sets the switch unit SW2c to second state until the output pointer PTO is updated. Then, the control unit CL2 switches the switch unit SW2c to the first state according to the update of the output pointer PTO.

The access processing unit ACP is the same as or similar to the access processing unit ACP depicted in FIG. 2. In FIG. 9, the memory mapping unit MMAP, the arbitration unit ARB, and the command generating unit CGEN depicted in FIG. 2 are omitted to make the diagram easier to see.

The memory reading unit MRU and the register REG are the same as or similar to the memory reading unit MRU and the register REG depicted in FIG. 2. The configuration of the memory controller MCLc is not limited to the example depicted in FIG. 9.

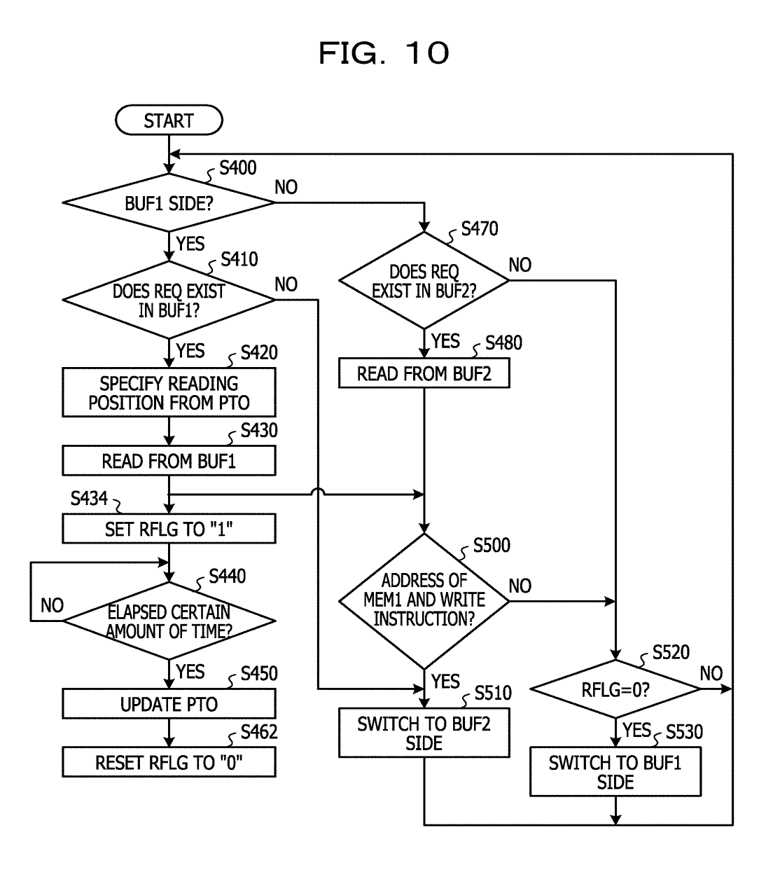

FIG. 10 illustrates an example of an operation of the second switch unit SW2c and the second control unit CL2 depicted in FIG. 9. The operation depicted in FIG. 10 is an operation of the memory controller MCLc when the request information REQ from one of the buffer units BUF1 and BUF2 is read. Steps that are the same as or similar to those described in FIG. 6 are denoted by the same or similar reference numerals, and a detailed description thereof will be omitted.

In step S400, it is determined whether or not the switch unit SW2c is set to a first state where the buffer unit BUF1 is accessible. In a case where the switch unit SW2c is set to the first state where the buffer unit BUF1 is accessible state, the operation of the memory controller MCLc proceeds to step S410. On the other hand, in a case where the switch unit SW2b is not set to the first state where the buffer unit BUF1 is accessible, that is, in a case where the switch unit SW2b is set to the second state where the buffer unit BUF2 is accessible, the operation of the memory controller MCLc proceeds to step S470.

In step S410, the switch unit SW2c determines whether or not the request information REQ that has not been read exists in the buffer unit BUF1. In a case where the request information REQ which has not been read exists in the buffer unit BUF1, the operation of the memory controller MCLc proceeds to step S420. Accordingly, the switch unit SW2c executes the process of step S420.

On the other hand, in a case where the request information REQ which has not been read does not exist in the buffer unit BUF1, the operation of the memory controller MCLc proceeds to step S510. Accordingly, the control unit CL2 executes the process of step S510.

In step S420, the switch unit SW2c refers to the output pointer PTO to specify a reading position.

Next, in step S430, the switch unit SW2c reads the request information REQ stored in the buffer unit BUF1 from the reading position specified in step S420. After the process of step S430 is executed, the operation of the switch unit SW2c of the memory controller MCLc proceeds to step S434, and the operation of the control unit CL2 of the memory controller MCLc proceeds to step S500.

In step S434, the switch unit SW2c sets the flag RFLG to a logical value “1”.

Next, in step S440, the switch unit SW2c determines whether or not a certain amount of time has elapsed. In a case the certain amount of time has elapsed, the operation of the switch unit SW2c returns to step S450. On the other hand, in a case the certain amount of time has not elapsed, the operation of the switch unit SW2c returns to step S440.

In step S450, the switch unit SW2c updates the output pointer PTO.

Next, in step S462, the switch unit SW2c resets the flag RFLG to a logical value “0”. In this way, the flag RFLG is set to a logical value “1” when data is read from the buffer unit BUF1, and reset to a logical value “0” in a case where the output pointer PTO is updated. That is, the flag RFLG is maintained as a logical value “1” until the data read from the buffer unit BUF1 is written to the non-volatile memory MEM1. After the process of step S462 is executed, the operation of the switch unit SW2c returns to step S400 by executing the process of step S530, which will be described later by the control unit CL2.

In step S470, the switch unit SW2c determines whether or not the request information REQ that has not been read exists in the buffer unit BUF2. In a case where the request information REQ which has not been read exists in the buffer unit BUF2, the operation of the memory controller MCLc proceeds to step S480. Accordingly, the switch unit SW2c executes the process of step S480. On the other hand, in a case where the request information REQ which has not been read does not exist in the buffer unit BUF2, the operation of the memory controller MCLc proceeds to step S520. Accordingly, the control unit CL2 executes the process of step S520.

In step S480, the switch unit SW2c reads the request information REQ stored in the buffer unit BUF2. After the process of step S480 is executed, the operation of the memory controller MCLc precedes to step S500. Accordingly, the control unit CL2 executes the process of step S500.

In step S500, the control unit CL2 determines whether or not the address and the instruction included in the request information REQ read by the switch unit SW2c is an address assigned to the non-volatile memory MEM1 and a write instruction. In a case where the address read by the switch unit SW2c is an address assigned to the non-volatile memory MEM1 and the instruction read by the switch unit SW2c is a write instruction, the operation of the control unit CL2 proceeds to step S510. That is, in a case where the data read by the switch unit SW2c is data to be written in the non-volatile memory MEM1, the operation of the control unit CL2 proceeds to step S510.

On the other hand, in a case where the address read by the switch unit SW2c is not an address assigned to the non-volatile memory MEM1 or the instruction read by the switch unit SW2c is not a write instruction, the operation of the control unit CL2 proceeds to step S520. That is, in a case where the data read by the switch unit SW2c is not data to be written in the non-volatile memory MEM1, the operation of the control unit CL2 proceeds to step S520.

In step S510, the control unit CL2 switches the switch unit SW2c to the second state where the buffer unit BUF2 is accessible. After the process of step S510 is executed, the operation of the memory controller MCLc returns to step S400. Accordingly, the switch unit SW2c executes the process of step S400.

In step S520, the control unit CL2 determines whether or not the flag RFLG is a logical value “0”. In a case where the flag RFLG is a logical value “0”, the operation of the control unit CL2 proceeds to step S530. On the other hand, in a case where the flag RFLG is not a logical value “0”, that is, in a case where the flag RFLG is a logical value “1”, the operation of the memory controller MCLc returns to step S400. Accordingly, the switch unit SW2c executes the process of step S400.

In step S530, the control unit CL2 switches the switch unit SW2c to the first state where the buffer unit BUF1 is accessible. After the process of step S530 is executed, the operation of the memory controller MCLc returns to step S400. Accordingly, the switch unit SW2c executes the process of step S400.

In this way, in a case where the address and the instruction received from the switch unit SW2c are an address assigned to the non-volatile memory MEM1 and a write instruction, the control unit CL2 sets the switch unit SW2c to second state until the output pointer PTO is updated. Then, in a case where the output pointer PTO is update, the control unit CL2 switches the switch unit SW2c to the first state. Accordingly, while writing data to the non-volatile memory MEM1, it is possible to execute the process based on the request information REQ stored in the buffer unit BUF2 and improve the processing ability of the information processing apparatus IPEc. The operation of the switch unit SW2c is not limited to the example depicted in FIG. 10.

As described above, in the embodiments depicted in FIGS. 9 to 10, the same effects as those of the embodiment depicted in FIGS. 2 to 8 may be obtained. For example, the control unit CL1 executes release of the fence instruction SFEN received from the processing unit PU in a case where the preceding data preceding the fence instruction SFEN is stored in one of the buffer units BUF1 and BUF2. Accordingly, it is possible to suppress an increase in waiting time for data transfer from the arithmetic processing unit PU to the memory controller MCLc.

Further, the control unit CL2 sets the switch unit SW2c to the second state while the process of writing data to the non-volatile memory MEM1 is being executed. Accordingly, the memory controller MCLc sequentially reads the request information REQ stored in the buffer unit BUF2 even while writing data to the non-volatile memory MEM1, and may sequentially execute the process based on the read request information REQ. As a result, it is possible to efficiently write data from the memory controller MCLc to the main storage device MMEM, and improve the processing ability of the information processing apparatus IPEc including the memory controller MCLc.

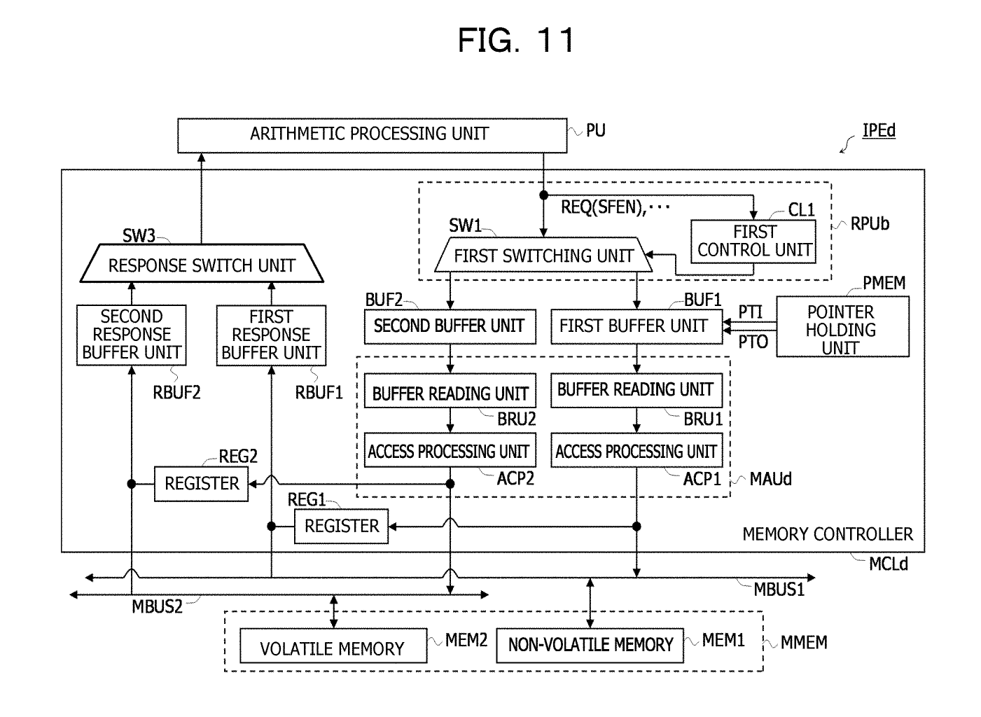

FIG. 11 is a diagram illustrating another embodiment of the memory controller and the memory access method. Elements that are the same as or similar to those described in FIGS. 1 to 10 are denoted by the same or similar reference numerals, and a detailed description thereof will be omitted. A memory controller MCLd depicted in FIG. 11 controls the main storage device MMEM including the non-volatile memory MEM1 and a volatile memory MEM2. For example, the memory controller MCLd includes a memory access unit MAUd instead of the memory access unit MAUb depicted in FIG. 2. In addition, the memory controller MCLd includes a response switch unit SW3, a first response buffer unit RBUF1, and a second response buffer unit RBUF2 instead of the memory reading unit MRU depicted in FIG. 2. Further, the memory controller MCLd includes registers REG1 and REG2 instead of the register REG depicted in FIG. 2. The other configurations of the memory controller MCLd are the same as or similar to that of the memory controller MCLb depicted in FIG. 2.

For example, an information processing apparatus IPEd includes the memory controller MCLd, the arithmetic processing unit PU and the main storage device MMEM. The memory controller MCLd is coupled to the non-volatile memory MEM1 via the bus MBUS1, and is coupled to the volatile memory MEM2 via the bus MBUS2. Then, the memory controller MCLd controls data transfer between the main storage device MMEM including the non-volatile memory MEM1 and the volatile memory MEM2, and the arithmetic processing unit PU.

The memory controller MCLd includes the first buffer unit BUF1, the second buffer unit BUF2, a pointer holding unit PMEM, the reception processing unit RPUb, and a memory access unit MAUd. Further, the memory controller MCLd includes registers REG (REG1, REG2), the first response buffer unit RBUF1, the second response buffer unit RBUF2, and a response switch unit SW3. Hereinafter, the first response buffer unit RBUF1 and the second response buffer unit RBUF2 are also referred to as buffer units RBUF1 and RBUF2, and the response switch unit SW3 is also referred to as a switch unit SW3.

The reception processing unit RPUb is the same as or similar to the reception processing unit RPUb depicted in FIG. 2. For example, the reception processing unit RPUb includes the control unit CL1 and the switch unit SW1. In a case where the address received from the arithmetic processing unit PU is an address assigned to the non-volatile memory MEM1, the control unit CL1 depicted in FIG. 11 sets the output destination of the switch unit SW1 in the buffer unit BUF1 irrespective of the type of the instruction. That is, in a case where the address received from the arithmetic processing unit PU is an address assigned to the volatile memory MEM2, the control unit CL1 depicted in FIG. 11 sets the output destination of the switch unit SW1 in the buffer unit BUF2 irrespective of the type of the instruction. Other operations of the control unit CL1 depicted in FIG. 11 are the same as or similar to those of the control unit CL1 shown in FIG. 2.

In addition, the switch unit SW1 depicted in FIG. 11 is the same as or the same as the switch unit SW1 shown in FIG. 2. For example, the switch unit SW1 updates the input pointer PTI after storing of data in the buffer unit BUF1 is completed.

The buffer units BUF1 and BUF2, and the pointer holding unit PMEM are the same as or similar to the buffer units BUF1 and BUF2, and the pointer holding unit PMEM depicted in FIG. 2.

The memory access unit MAUd includes buffer reading units BRU1 and BRU2 instead of the second switch unit SW2b depicted in FIG. 2. In addition, the memory access unit MAUd includes the access processing units ACP1 and ACP2 instead of the access processing unit ACP depicted in FIG. 2. The other configurations of the memory access unit MAUd are the same as or similar to that of the memory access unit MAUb depicted in FIG. 2. That is, the memory access unit MAUd includes the buffer reading units BRU1 and BRU2, the access processing units ACP1 and ACP2.

The buffer reading unit BRU1 reads the request information REQ stored in the buffer unit BUF1 from the reading position indicated by the output pointer PTO. Then, the buffer reading unit BRU1 transfers the request information REQ read from the buffer unit BUF1 to the access processing unit ACP1. In addition, the buffer reading unit BRU1 updates the output pointer PTO after the data included in the request information REQ read from the reading position indicated by the output pointer PTO is written to the non-volatile memory MEM1.

In this way, the buffer reading unit BRU1 reads the data stored in the buffer unit BUF1 from the reading position indicated by the output pointer PTO, and updates the output pointer PTO after the read data is written to the non-volatile memory MEM1.

The buffer reading unit BRU2 reads the data stored in the buffer unit BUF2, and transfers the read data to the access processing unit ACP2.

The access processing units ACP1 and ACP2 are the same as or similar to the access processing unit ACP depicted in FIG. 2. In FIG. 11, the memory mapping unit MMAP, the arbitration unit ARB, and the command generating unit CGEN depicted in FIG. 2 are omitted to make the diagram easier to see. For example, the access processing unit ACP1 writes the data transferred from the buffer unit BUF1 via the buffer reading unit BRU1 to the non-volatile memory MEM1. In addition, for example, the access processing unit ACP2 writes the data transferred from the buffer unit BUF2 via the buffer reading unit BRU2 to the non-volatile memory MEM.

The register REG1 sequentially holds data and the like output from the access processing unit ACP1. Accordingly, the memory controller MCLd may transfer data to be read from the register REG1 to the buffer unit RBUF1 even while the data to be read requested by a read instruction is being written to the non-volatile memory MEM1.

The register REG2 sequentially holds data and the like output from the access processing unit ACP2. Accordingly, the memory controller MCLd may transfer data to be read from the register REG2 to the buffer unit RBUF2 even while the data to be read requested by a read instruction is being written to the volatile memory MEM2.

The buffer unit RBUF1 receives data to be read requested by a read instruction from the non-volatile memory MEM1 or the register REG1 or the like, and holds the received data. That is, the buffer unit RBUF1 receives the data read from the non-volatile memory MEM1 and holds the received data.

The buffer unit RBUF2 receives data to be read requested by a read instruction from the volatile memory MEM2 or the register REG2 or the like, and holds the received data. That is, the buffer unit RBUF2 receives the data read from the volatile memory MEM2 and holds the received data.

In a case where the switch unit SW3 is set to a first response state where the buffer unit RBUF1 is accessible, the switch unit SW3 transfers the data held in the buffer unit RBUF1 to the arithmetic processing unit PU. In addition, in a case where the switch unit SW3 is set to a second response state where the buffer unit RBUF2 is accessible, the switch unit SW3 transfers the data held in the buffer unit RBUF2 to the arithmetic processing unit PU.

In this way, in the memory controller MCLd, the non-volatile memory MEM1 is coupled to the bus MBUS1 which is different from the bus MBUS2 to which the volatile memory MEM2 is coupled. Therefore, the output from the memory controller MCLd to the main storage device MMEM is separated into two systems. In this case, as described above, the control unit CL1 switches the output destination of the switch unit SW1 by determining whether or not the address received from the arithmetic processing unit PU is an address assigned to the non-volatile memory MEM1. In addition, in hardware initialization at a boot sequence, the output destination of the switch unit SW1 is set in the buffer unit BUF2 as described in FIG. 8. Accordingly, the memory controller MCLd may avoid the data stored in the buffer unit BUF1 from being erased. The operation at the boot sequence of the information processing apparatus IPEd is explained by omitting step S1200 from the operation thereof depicted in FIG. 8 and replacing the switch unit SW2b with the buffer reading unit BRU1. The configuration of the memory controller MCLd is not limited to the example depicted in FIG. 11.

As described above, in the embodiments depicted in FIG. 11, the same effects as those of the embodiment depicted in FIGS. 2 to 8 may be obtained. For example, the control unit CL1 executes release of the fence instruction SFEN received from the processing unit PU in a case where the preceding data preceding the fence instruction SFEN is stored in one of the buffer units BUF1 and BUF2. Accordingly, it is possible to suppress an increase in waiting time for data transfer from the arithmetic processing unit PU to the memory controller MCLd.

Further, in the memory controller MCLd, the output to the main storage device MMEM is separated into two systems, an output to the non-volatile memory MEM1 and an output to the volatile memory MEM2. Accordingly, the memory controller MCLd sequentially reads the request information REQ stored in the buffer unit BUF2 even while writing data to the non-volatile memory MEM1, and may sequentially execute the process based on the read request information REQ. As a result, it is possible to efficiently write data from the memory controller MCLd to the main storage device MMEM, and improve the processing ability of the information processing apparatus IPEd including the memory controller MCLd.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a first memory;
a processor; and
a memory control circuit including a first buffer and coupled to the first memory and the processor,
wherein the memory control circuit is configured to:
execute receiving first data from the processor,
after the receiving of the first data, receive, from the processor, a request that requires to restrict a change in write order of a plurality of pieces of data including the first data to the first memory,
determine whether a storing process of the first data into the first buffer is executed,
transmit a first notification to the processor when the storing process of the first data into the first buffer is executed,
receive second data included in the plurality of pieces of data transmitted from the processor based on the first notification,
store the second data into the first buffer,
execute a first writing process of writing the first data stored in the first buffer to the first memory, and
execute a second writing process of writing the second data stored in the first buffer to the first memory after the first writing process.

2. The information processing apparatus according to claim 1, wherein the memory control circuit is configured to:
generate an input pointer indicating a data input position of the first buffer with respect to the plurality of pieces of data transmitted from the processor,
input the first data and the second data to the first buffer based on the input pointer,
generate an output pointer indicating a data output position from the first buffer with respect to the plurality of pieces of data stored in the first buffer,
output the first data and the second data from the first buffer based on the output pointer, and
execute the first writing process and the second writing process.

3. The information processing apparatus according to claim 1,
wherein the order of input of the plurality of pieces of data into the first buffer and the order of output of the plurality of pieces of data from the first buffer are the same with each other.

4. The information processing apparatus according to claim 1,
wherein the first memory is a non-volatile memory.

5. The information processing apparatus according to claim 1,
wherein the first buffer is a non-volatile buffer.

6. The information processing apparatus according to claim 2, further comprising:
a second memory coupled to the memory control circuit,
wherein the memory control circuit further includes:
a second buffer,
a first switch configured to receive write data from the processor, to input the write data to a position indicated by the input pointer of the first buffer when a write destination of the write data is the first memory, and to input the write data to the second buffer when the write destination of the write data is the second memory,
a first control circuit configured to set an output destination of the first switch to the first buffer when the write destination of the write data is the first memory,
a second switch configured to read the write data stored in the first buffer from a position indicated by the output pointer in a first state where the first buffer is accessible, and to read the write data stored in the second buffer in a second state where the second buffer is accessible, and
an access processing circuit configured to write the write data transferred from the first buffer via the second switch to the first memory, and to write the write data transferred from the second buffer via the second switch to the second memory.

7. The information processing apparatus according to claim 6, wherein
when an address of the write data is an address allocated to the first memory, the first control circuit is configured to set the output destination of the first switch to the first buffer.

8. The information processing apparatus according to claim 6, wherein
the first switch updates the input pointer after storing of the write data into the first buffer is executed.

9. The information processing apparatus according to claim 6, wherein
when the write data stored in the first buffer is written to the first memory, the second switch is configured to update the output pointer after the write data read from the position indicated by the output pointer is written to the first memory.

10. The information processing apparatus according to claim 6, further comprising:
a memory reading circuit configured to receive read data to be read from at least one of the first memory and the second memory and to transfer the read data to the processor, wherein
the first switch is configured to set an output destination in the second buffer during an initialization process executed by the processor when the processor is powered on,
the second switch is configured to be set to the second state during the initialization process, to be switched to the first state after the initialization process, and to determine whether there is residual data remaining in the first buffer without being written to the first memory in a previous operation prior to power shutdown based on the comparison result between the input pointer and the output pointer, and
the access processing circuit is configured to write the residual data stored in the first buffer to the first memory when the residual data is stored in the first buffer.

11. The information processing apparatus according to claim 6, wherein
the second switch is configured to alternately select the first state and the second state for every access from the processor.

12. The information processing apparatus according to claim 6, wherein the memory control circuit is configured to:
set the second switch to the second state until the output pointer is updated, and
switch the second switch to the first state in response to the update of the output pointer when the address is an address assigned to the first memory and an instruction output from the second switch is a write instruction.

13. The information processing apparatus according to claim 2, further comprising:
a second memory coupled to the memory control circuit, wherein the memory control circuit further includes:
a second buffer configured to store write data to be written to the second memory,
a third buffer configured to store first read data to be read from the first memory,
a fourth buffer configured to store second read data to be read from the second memory,
a third switch configured to transfer the read data stored in the third buffer to the processor in a third state where the third buffer is accessible, and to transfer the read data stored in the fourth buffer to the processor in a fourth state where the fourth buffer is accessible,
a first switch configured to input write data to a position indicated by the input pointer of the first buffer when a write destination of the write data is the first memory, and inputs the write data to the second buffer when the write destination of the write data is the second memory,
a first control circuit configured to set an output destination of the first switch in the first buffer when the write destination of the write data is the first memory,
a first buffer reading circuit configured to read the write data stored in the first buffer from a position indicated by the output pointer,
a second buffer reading circuit configured to read the write data stored in the second buffer,
a first access processing circuit configured to write the write data transferred from the first buffer through a first buffer reading unit to the first memory, and
a second access processing circuit configured to write the write data transferred from the second buffer through a second buffer reading unit to the second memory.

14. The information processing apparatus according to claim 13, wherein
the first switch is configured to update the input pointer after storing of the write data to the first buffer is executed.

15. The information processing apparatus according to claim 13, wherein
the first buffer reading unit is configured to update the output pointer after writing the write data read from the output position indicated by the output pointer to the first memory.

16. The information processing apparatus according to claim 13, wherein
the first switch is configured to set an output destination in the second buffer during an initialization process executed by the processor when the processor is powered on,
the first buffer reading circuit is configured to determine whether there is residual data remaining in the first buffer without being written to the first memory in a previous operation prior to power shutdown based on the comparison result between the input pointer and the output pointer after the initialization process, and
the first access processing circuit configured to write the residual data stored in the first buffer to the first memory when the residual data is stored in the first buffer.

17. The information processing apparatus according to claim 13, wherein
when the address is an address allocated to the first memory, the first control circuit is configured to set the output destination of the first switch to the first buffer.

18. A method of accessing a memory using a memory control circuit including a first buffer and coupled to the memory and a processor, the method comprising:
receiving first data from the processor;
after the receiving of the first data, receiving, from the processor, a request that requires to restrict a change in write order of a plurality of pieces of data including the first data to the first memory;
determining whether a storing process of the first data into the first buffer is executed;
transmittng a first notification to the processor when the storing process of the first data into the first buffer is executed;
receiving second data included in the plurality of pieces of data transmitted from the processor based on the first notification;
storing the second data into the first buffer;
executing a first writing process of writing the first data stored in the first buffer to the first memory; and
executing a second writing process of writing the second data stored in the first buffer to the first memory after the first writing process.

19. The method according to claim 18, further comprising:
generating an input pointer indicating a data input position of the first buffer with respect to the plurality of pieces of data transmitted from the processor;
inputting the first data and the second data to the first buffer based on the input pointer;
generating an output pointer indicating a data output position from the first buffer with respect to the plurality of pieces of data stored in the first buffer;
outputting the first data and the second data from the first buffer based on the output pointer; and
executing the first writing process and the second writing process.

20. The method according to claim 18,
wherein the order of input of the plurality of pieces of data into the first buffer and the order of output of the plurality of pieces of data from the first buffer are the same with each other.
